(19) United States
(12) Patent Application Publication
(10) Pub. No.: US 2024/0202754 A1
(43) Pub. Date: Jun. 20, 2024

(54) METHOD FOR IDENTIFYING PROSPECTS BASED ON A PROSPECT MODEL

(71) Applicant: HUBSPOT, INC., Cambridge, MA (US)

(72) Inventors: Wade TANDY, San Francisco, CA (US); Guilherme VIEIRA, San Francisco, CA (US); Harlow WARD, San Francisco, CA (US); Zachary SWETZ, San Francisco, CA (US); Andrew O'NEAL, San Francisco, CA (US); Saagar GUPTA, San Francisco, CA (US)

(21) Appl. No.: 18/541,696

(22) Filed: Dec. 15, 2023

Related U.S. Application Data
(60) Provisional application No. 63/432,855, filed on Dec. 15, 2022.

(51) Int. Cl. G06Q 30/0202; G06Q 30/0204

(52) U.S. Cl. CPC G06Q 30/0202; G06Q 30/0204

(57) ABSTRACT

Systems and methods are provided for identifying prospects based on a prospect model. A set of primary features are extracted from historical data for an opportunity between an organization and an entity. A data container is generated to represent the set of primary features and a set of secondary features associated with the entity. Neighboring data containers, within a set of data containers that includes the data container, are grouped into data container groups. A data container group is selected to represent a combination of features of the entity predicted to yield the opportunity for the organization. The combination of features are used to generate and transmit content to the entity.

This application claims priority to U.S. Provisional patent application, titled “METHOD FOR IDENTIFYING PROSPECTS BASE ON A PROSPECT MODEL”, filed on Dec. 15, 2022 and accorded application No. 63/432,855, which is incorporated herein by reference.

### BACKGROUND

Conventional systems for enabling marketing and sales activities for a client do not also respectively enable support and service interactions with customers, notwithstanding that the same individuals are typically involved in all of those activities for a business, transitioning in status from prospect, to customer, to client. While marketing activities, sales activities, and service activities strongly influence the success of each other, businesses are required to undertake complex and time-consuming tasks to obtain relevant information for one activity from the others. These tasks may include forming queries, using complicated APIs, or otherwise extracting data from separate databases, networks, or other information technology systems (some on premises and others in the cloud). The task may also include transforming data from one native format to another suitable form for use in a different environment, synchronizing different data sources when changes are made in different databases, normalizing data, cleansing data, and configuring it for use.

Many organizations store data within customer relationship management (CRM) systems. A client of the organization can access customer information that is stored as objects within a CRM system of a multi-client service system platform. The customer information may relate to customers of the organization, such as contact information, sales information, help desk tickets, and/or a variety of information related to the organization and/or customers of the organization. The CRM system can be used to store core objects natively provided by the CRM system and/or custom objects that are custom created and configured by the client.

CRM systems may generally provide the ability to manage and analyze interactions with customers for businesses. For example, these CRM systems may compile data from various communication channels (e.g., email, phone, chat, content materials, social media, etc.). Some CRM systems can be used to monitor and track CRM standard objects (core objects). These CRM standard objects can include typical business objects such as accounts (e.g., accounts of customers), contacts (e.g., persons associated with accounts), leads (e.g., prospective customers), and opportunities (e.g., sales or pending deals).

### DESCRIPTION OF THE DRAWINGS

Embodiments of the present technology will be described and explained through the use of the accompanying drawings in which:

FIG. 1 is a block diagram illustrating an embodiment of a system for identifying prospects based on a prospect model in accordance with an embodiment of the present technology.

FIG. 2A is a flow chart illustrating an embodiment of a method for identifying prospects based on a prospect model in accordance with various embodiments of the present technology.

FIG. 2B is a flow chart illustrating an embodiment of a method for identifying prospects based on a prospect model in accordance with various embodiments of the present technology.

FIG. 2C is a flow chart illustrating an embodiment of a method for identifying prospects based on a prospect model in accordance with various embodiments of the present technology.

FIG. 3A is a block diagram illustrating an embodiment of a system for identifying prospects based on a prospect model in accordance with an embodiment of the present technology.

FIG. 3B is a block diagram illustrating an embodiment of a system for identifying prospects based on a prospect model in accordance with an embodiment of the present technology.

FIG. 3C is a block diagram illustrating an embodiment of a system for identifying prospects based on a prospect model in accordance with an embodiment of the present technology.

FIG. 3D is a block diagram illustrating an embodiment of a system for identifying prospects based on a prospect model in accordance with an embodiment of the present technology.

FIG. 4 is an example of a computer readable medium in which an embodiment of the present technology may be implemented.

FIG. 5 illustrates an exemplary computing environment wherein one or more of the provisions set forth herein may be implemented.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

System and methods are provided for generating prospect profiles and reports that can be utilized to execute various computer implemented operations by a computer device. A prospect profile (e.g., an ideal prospect profile) may specify attributes of a customer that may have a high probability of successfully completing an opportunity. For example, an organization may have an opportunity with customers. In some embodiments, the opportunity may relate to providing information to a customer (e.g., programmatically generating and transmitting an email describing or illustrating a product or service), selling a product or service to the customer (e.g., constructing and displaying a purchase user interface with electronic purchase completion functionality), negotiating a contract with the customer (e.g., programmatically generating and providing a contract proposal for the customer), sharing an opinion or idea with the customer, etc. In some embodiments, the opportunity may relate to performing an upgrade of hardware or software, performing a configuration for a computing device of the customer, installing software on the computing device of the customer, performing a computer implemented transaction between the customer and the organization. In some embodiments, the opportunity may relate to creating an object within a customer relationship management (CRM) database relating to the customer, generating content to display to the customer through a computing device, etc.

Various computer implemented operations may be performed by the computing device based upon the identification of a prospect matching one or more attributes within a prospect profile. In some embodiments, the operations may include generating and transmitting custom content to a computing device for display to the customer (e.g., a customized email, text message, text and image, a notification, a report, or any other information or content that may be related to the organization, the customer, and/or the opportunity). In some embodiments, the operations may include remotely transmitting and installing software on the computing device, performing a remote upgrade for the computing device, etc. In some embodiments, the operations may include generating a service ticket populated with troubleshooting information extracted from the computing device (e.g., a debug log populated with information relating to a software crash), sending troubleshooting instructions to the computing device, performing a remote takeover of the computing device to perform troubleshooting, sending a security code to the computing device for authentication, etc. In some embodiments, the operations may include performing a purchase transaction, creating an object within the CRM database, generating an account within a CRM system, etc.

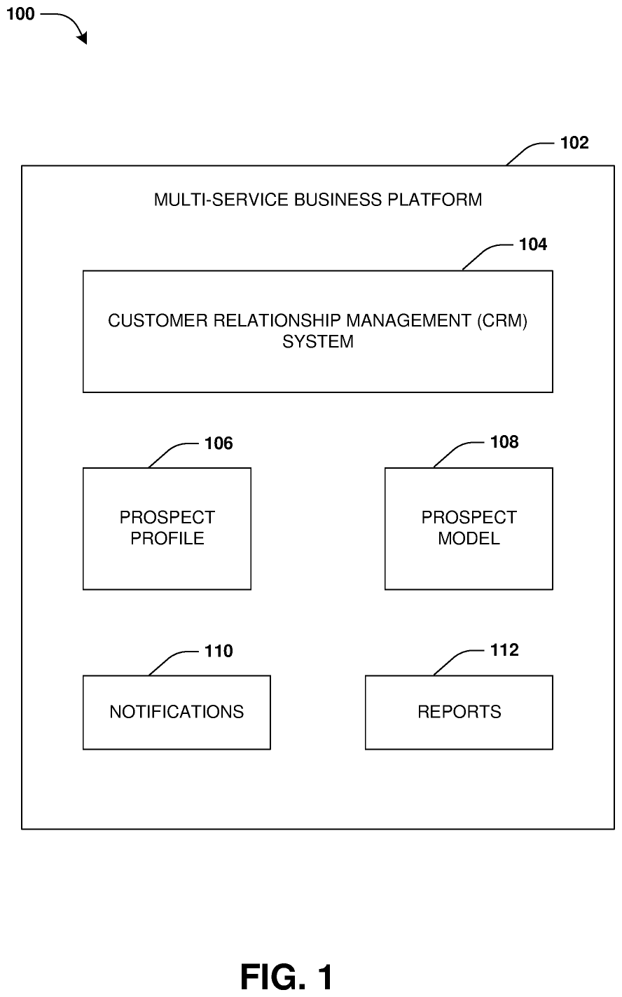

FIG. 1 is a block diagram illustrating an embodiment of a system 100 for identifying prospects based on a prospect model. The system 100 includes a multi-service business platform 102 (referred to herein also as multi-tenant distributed system or multi-function business platform (“platform”) or framework system which is provided by a computing device. The multi-service business platform 102 may communicate with various systems, devices, and data sources. The multi-service business platform 102 may serve the needs of multiple clients (e.g., employees of an organization, such as sales team members, technical support team members, etc.) who in turn use the multi-service business platform 102 to provide services, support, etc. for their customers or end users. The multi-service business platform 102 of the computing device includes a customer relationship management (CRM) system 104 in an aspect of the present disclosure. The CRM system 104 comprises a CRM database within which objects are stored (e.g., core objects natively provided by the CRM system 104 and/or custom objects that are custom created and configured by clients of the CRM system 104). The objects may store information about customers, potential customers, contacts, businesses, entities, organizations, tickets (e.g., a service ticket for troubleshooting a problem), sales information, human resource information, financial information, etc.

Information within the CRM system (e.g., information within objects stored within the CRM database), company information of customers or potential customers, web traffic data (e.g., information related to users accessing a website associated with an organization or other website), etc. may be used to generate a prospect profile 106 (e.g., an ideal prospect profile). The information may also be used by a prospect model 108 to generate fit scores based upon similarities between prospects (e.g., potential customers or existing customers of the organization) and a data container group of data containers representing combinations of features of entities (e.g., existing customers or potential customers) predicted to successfully complete an opportunity with the organization. The fit scores are used to generate notifications 110 and reports 112 of prospects and/or attributes of prospects that may have a high probability of successfully completing the opportunity with the organization. Accordingly the notifications and reports 112 may be used to implement various computer implemented operations.

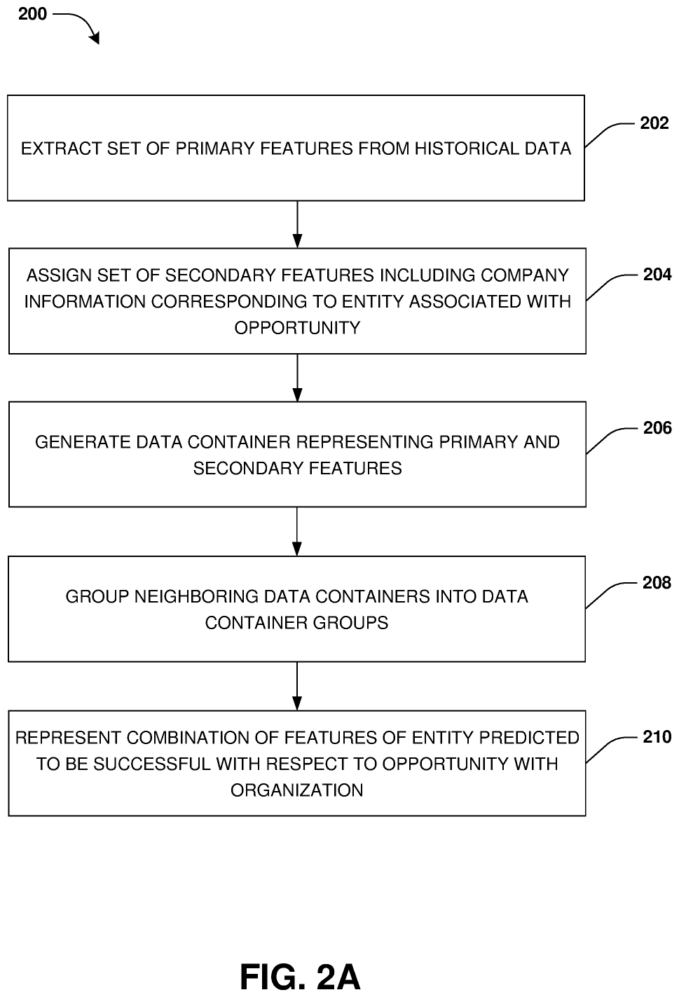

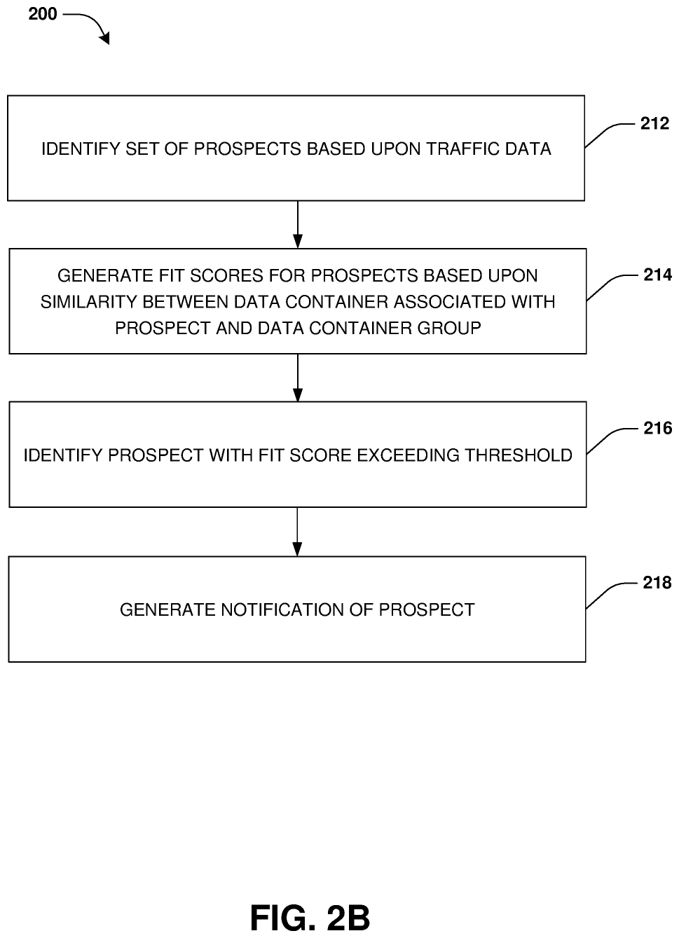

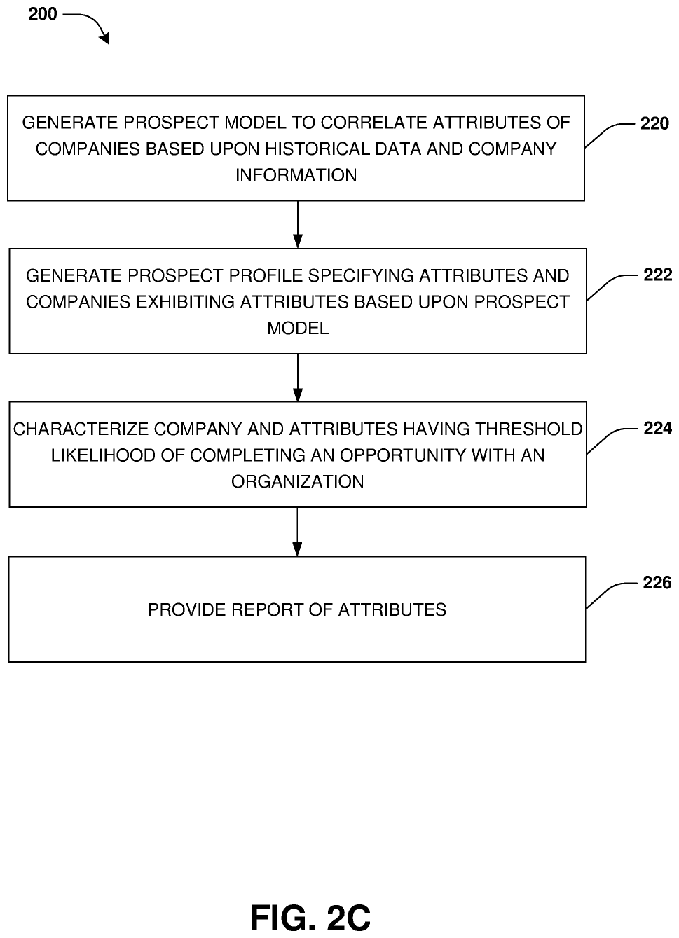

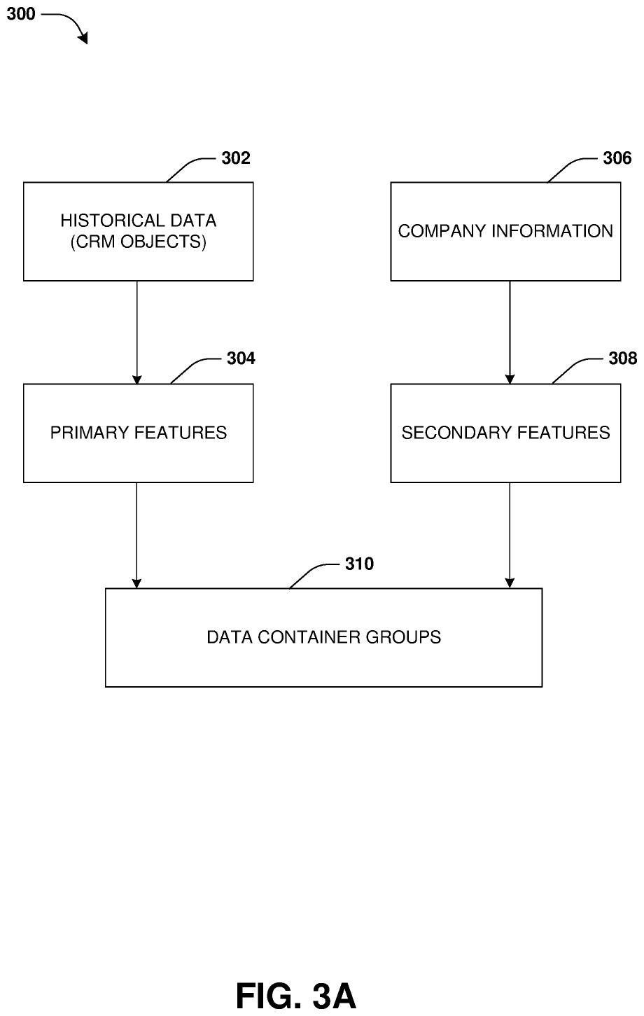

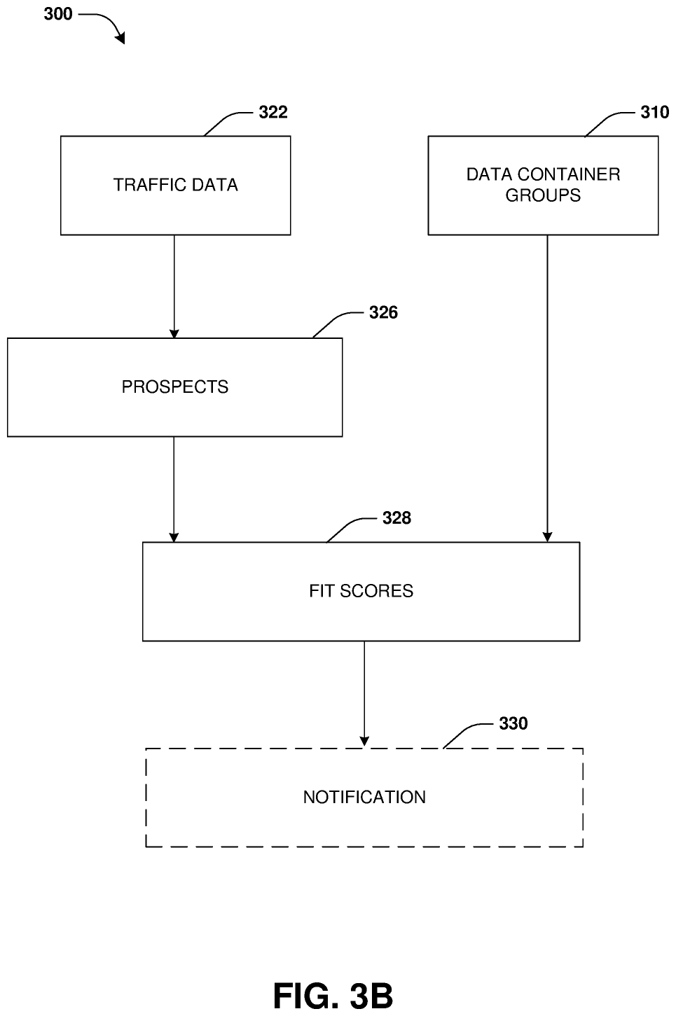

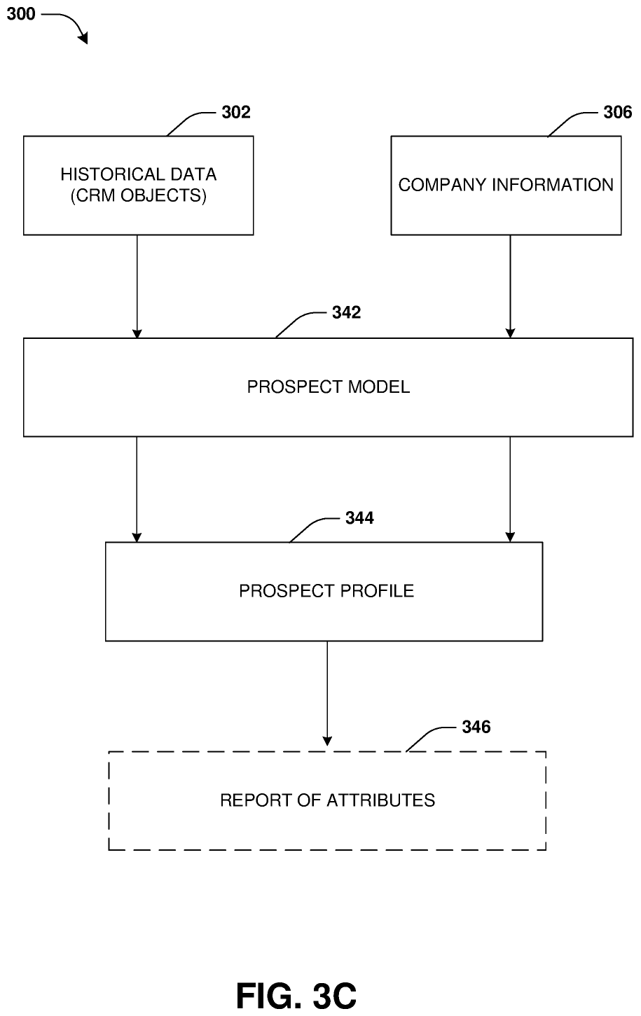

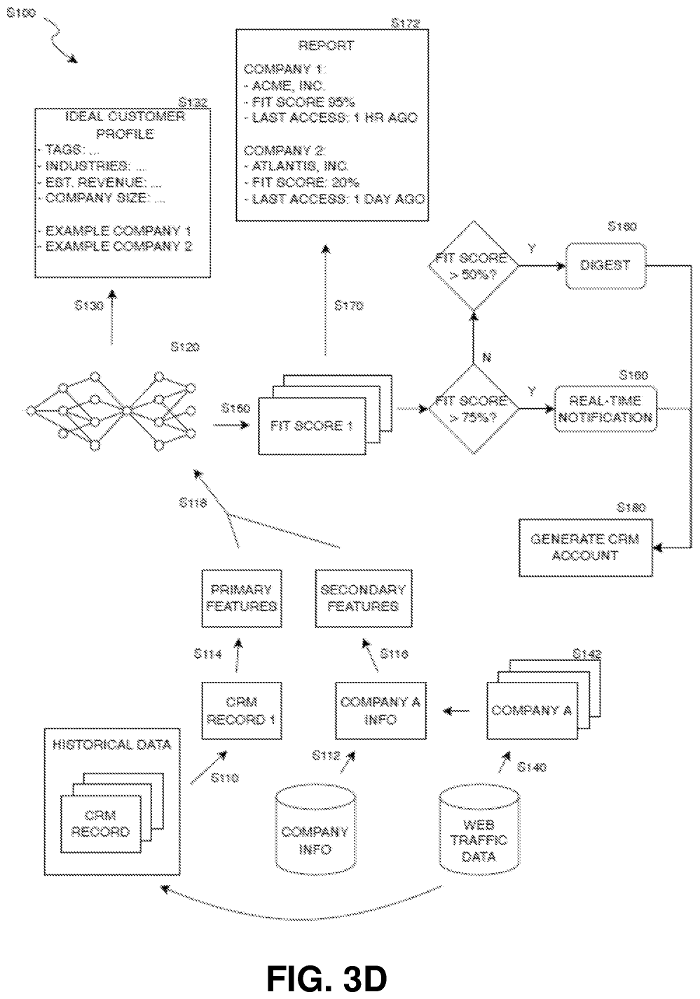

FIGS. 2A-2C are flow charts illustrating an embodiment of a method 200 for identifying prospects based on a prospect model, which are described in conjunction with system 300 of FIGS. 3A-3C. During operation 202 of method 200, a set of primary features 304 are extracted by the system 300 from historical data 302, as illustrated by FIG. 3A. The set of primary features 304 may include a name, a duration of time of a sales process, a result of a sale, a sales amount, and/or any other information that may be stored within objects of a CRM system and database. During operation 204 of method 200, a set of secondary features 308, including company information 306 corresponding to an entity associated with an opportunity, are assigned. The entity may relate to a person, company, or any other entity that could be a customer or potential customer of an organization that stores information within objects in the CRM database accessible to clients of the organization (e.g., a client such a sales team member, a technical support member, a payroll team member, or any other person/user of an organization that interacts with existing and/or potential customers of the organization). The set of secondary features 308 correspond to information about the entity such as a company size, an industry of a company, a revenue of the company, keywords/tags describing the company, etc.

During operation 206 of method 200, a data container is generated to represent the set of primary features 304 and the set of secondary features 308. The data container may be implemented as a vector or other data structure that represents the set of primary features 304 and the set of secondary features 308 such as within multi-dimensional space. A plurality of data containers may be created for features of various entities, opportunities, and/or organizations. During operation 208 of method 200, neighboring data containers of the plurality of data containers are grouped to create data container groups 310. The neighboring data containers may be grouped in a multi-dimensional feature space. A data container group represents a combination of features (e.g., primary features and/or secondary features) of an entity (e.g., a customer or potential customer) that is predicted to yield a successful opportunity with the organization (e.g., features of a potential customer that is likely to purchase a product or service sold by the organization). In this way, a combination of features of an entity predicted as being successful with respect to an opportunity is represented by the data container group(s), during operation 210 of method 200.

During operation 212 of method 200, a set of prospects 326 are identified based upon the traffic data 322, as illustrated by FIG. 3B. The traffic data 322 may correspond to page views for a website associated with the organization (e.g., users visiting the website of the organization). The traffic data 322 is used to identify the set of prospects 326 (e.g., users (e.g., a prospect such as a potential customer or existing customer with respect to a particular opportunity) that may have an interest in the organization such as a product or service of the organization). During operation 214 of method 200, fit scores 328 are generated for the set of prospects 326 based upon similarities between data containers associated with the prospects and the data container groups 310. In particular, a fit score may be assigned to each prospect. The fit score may correspond to a similarity between a data container associated with a prospect and the organization (e.g., a data container of primary and secondary features of an entity/prospect in relation to an opportunity with the organization).

During operation 216 of method 200, the fit scores are evaluated against a threshold to identify any fit scores that exceed the threshold. The threshold may relate to a probability that a prospect will successfully complete an opportunity with the organization (e.g., a high fit score for a prospect/potential customer indicates that the prospect is likely to purchase a product or service sold by the organization). During operation 218 of method 200, a notification 330 is generated for a prospect assigned a first score that exceeds the threshold. The notification 330 may describe information related to the prospect such as company information and attributes of the prospect (e.g., a company name, size, type of business conducted, etc.).

During operation 220 of method 200, a prospect model 342 is generated to correlate attributes of companies based upon the historical data 302 and the company information 306, as illustrated by FIG. 3C. The prospect model 342 may correlate attributes of companies, entities, and/or users that completed an opportunity with the organization such as by completing a sale with the organization. During operation 222 of method 200, a prospect profile (e.g., an ideal prospect profile) is generated. The prospect profile specifies attributes and a set of companies that exhibit a threshold (high) likelihood of completing an opportunity with the organization such as by completing a sale with the organization. The prospect profile 344 may provide a visualization of combinations of prospect that would be worthwhile to pursue with respect to an opportunity because prospects (e.g., customers or potential customers) with such combinations of attributes may have a high likelihood of successfully completing an opportunity of the organization such as by completing a sale with the organization. In this way, a prospect/company and the attributes may be characterized, during operation 224 of method 200. During operation 226 of method 200, a report of the attributes may be generated and provided to a user (e.g., a client of the organization).

In some embodiments, various computer implemented operations may be performed based upon the report 346. In particular, the computer implemented operations may be performed based upon the identification of a prospect matching one or more attributes within the prospect profile 344, as described by the report 346. In some embodiments, the operations may include generating and transmitting custom content to a computing device for display to the customer (e.g., a customized email, text message, text and image, a notification, a report, or any other information or content that may be related to the organization, the customer, and/or the opportunity). In some embodiments, the operations may include installing software on the computing device, performing an upgrade for the computing device, generating a service ticket populated with troubleshooting information extracted from the computing device (e.g., a debug log populated with information relating to a software crash), sending troubleshooting instructions to the computing device, performing a remote takeover of the computing device to perform troubleshooting, sending a security code to the computing device for authentication, etc. In some embodiments, the operations may include, performing a purchase transaction, creating an object within the CRM database, generate an account within a CRM system, etc.

As shown in FIG. 3D, a method S100 includes, during a first time period: accessing historical data (e.g., customer relationship management records) associated with an organization (e.g., a business) and a population of entities (e.g., existing customers of the organization, prospective customers) in block S110, the historical data representing a set of opportunities between the organization and the population of entities; and accessing company information associated with the population of entities in block S112. The method further includes, for each opportunity in the set of opportunities: extracting a set of primary features (e.g., name, duration of time in sale process, result, sales amount) from the historical data in block S114; assigning, as a set of secondary features, company information corresponding to an entity associated with an opportunity in block S116; generating a data container (e.g., vector), in a set of data containers, representing the set of primary features and the set of secondary features in a multi-dimensional feature space in block S118; and grouping neighboring data containers, in the set of data containers, in the multi-dimensional feature space into a set of data container groups in block S120, the set of data container groups including a first data container group representing a first combination of features of an entity predicted to yield closed-won opportunities with the organization.

The method S100 further includes, during a second time period succeeding the first time period: accessing a set of traffic data corresponding to a set of page views on a website associated with the organization in block S140; identifying a set of prospects based on the set of traffic data in block S142; calculating, for each prospect in the set of prospects, a fit score—in a set of fit scores—based on a similarity between a data container associated with a prospect and the first data container group in block S150; and, in response to detecting a first fit score in the set of fit scores associated with a first prospect in the set of prospects exceeding a threshold, generating a notification indicating the first prospect in block S150.

Generally, blocks of the method S100 can be executed by a computer system to: generate a model characterizing attributes of a prospect (e.g., a company) for an organization (e.g., business); identify a set of companies that have visited a target website (e.g., a website affiliated with the organization); calculate a fit score for each company in the set of companies based on the model, the fit score representing a likelihood of a company completing a sale with the organization; select a subset of companies—in the set of companies—based on fit scores of the subset of companies exceeding a threshold; and serve a notification (or a set of notifications) indicating at least one company in the subset of companies.

More specifically, blocks of the method S100 can be executed by the computer system (e.g., a remote server, a computer network) to: access historical data (e.g., customer relationship management (or “CRM”) records) associated with the organization and a population of companies (e.g., opportunities between the organization and the population of companies); access company information associated with the population of companies; and generate a prospect model—that correlates attributes of companies associated with a completed sale with the organization—based on the historical data and the company information. The computer system can further generate a prospect profile (e.g., an ideal prospect profile)—that specifies a list of these attributes and a set of companies exhibiting these attributes—based on the prospect model. Accordingly, the computer system can proactively characterize and recommend attributes of companies exhibiting high likelihood of completing a sale with the organization, thereby enabling a client to visualize combinations of attributes to pursue in a potential customer (e.g., a prospect) to increase a likelihood of completing a sale.

In one example application, blocks of the method S100 can be executed by the computer system to: access traffic data associated with a website of an organization; correlate a set of IP addresses within the traffic data with a set of prospects associated with the set of IP addresses; calculate, for each prospect in the set of prospects, a fit score based on the prospect model; generate a first type of notification (e.g., a real-time notification) specifying a first subset of prospects, in the set of prospects, exhibiting a fit score falling within a first range of fit scores (e.g., 75-100%); and generate a second type of notification (e.g., a weekly digest notification) specifying a second subset of prospects, in the set of prospects, exhibiting a fit score falling within a second range of fit scores (e.g., 50-74%). Accordingly, the computer system can: identify prospects exhibiting an interest in the organization (e.g., by visiting a website of the organization); and specify these prospects in different types of notifications (e.g., real-time notification, weekly digest) based on fit scores of these prospects, thereby enabling a client to leverage a prospect's active interest in the organization while prioritizing prospects exhibiting highest likelihood of completing a sale with the organization.

In another example application, blocks of the method S100 can be executed by the computer system to: access traffic data associated with a website of an organization; correlate a set of IP addresses within the traffic data with a set of prospects associated with the set of IP addresses; calculate, for each prospect in the set of prospects, a fit score based on the prospect model; and autonomously generate CRM platform accounts and assign these accounts to account owners based on a fit score of a prospect and/or attributes of the prospect. Accordingly, the computer system can autonomously: generate CRM platform accounts for qualified prospects (e.g., prospects exhibiting a fit score exceeding a threshold); and assign these accounts to various account owners associated with the organization based on fit scores and/or attributes of these prospects, thereby enabling the organization to pair prospects with personnel (e.g., account owners) that best match needs of these prospects.

The method S100, as described herein, is executed by a computer system to: generate a prospect model characterizing attributes of a prospect most likely to yield a closed-won opportunity with the organization (i.e., most likely to complete a sale with an organization). However, the computer system can similarly execute blocks of the method S100 to: generate the prospect model characterizing attributes of a prospect most likely to yield a qualified lead for a marketing team and/or most likely to yield a sales accepted lead for a sales team; calculate a set of fit scores for a set of prospects based on the prospect model; and present a notification specifying the set of prospects (or a subset of prospects) and the set of fit scores to a client.

Furthermore, the method S100 is described herein is executed by a computer system to: generate a prospect model for an organization; calculate a set of fit scores for a set of prospects based on the prospect model; and generate a notification(s) based on the set of fit scores. However, the computer system can similarly execute blocks of the method S100 to: generate multiple prospect models (e.g., enterprise, mid-size business, small business different, different product lines) for an organization; calculate multiple sets of fit scores for multiple sets of prospects based on the prospect models; and serve separate notifications to various clients based on the sets of fit scores.

Generally, an “organization” as referred to herein is a business (e.g., a company) accessing and/or utilizing the computer system, the multi-service business platform 102, and/or the CRM system 104.

Generally, a “client” as referred to herein is a user (e.g., analyst, sales manager, account owner, an employee) affiliated with the organization.

Generally, a “customer” as referred to herein is a company for which the organization has engaged services.

Generally, a “prospect” as referred to herein is a company that is a prospective customer for the organization.

Generally, an “entity” as referred to herein is a company that is an existing customer and/or known prospect of the organization.

Generally, an “opportunity” as referred to herein is a discrete instance of a sales process between the organization and a company.

Generally, a “closed-won opportunity” as referred to herein is an opportunity exhibiting a completed sales process and resulting in a sale between the organization and a company.

Generally, a “closed-lost opportunity” as referred to herein is an opportunity exhibiting a completed sales process and resulting in an absence of a sale between the organization and a company.

### Prospect Model

Generally, the computer system can generate a prospect model for an organization (e.g., a business) based on: historical data associated with the organization and a population of entities (e.g., customers, prospects); and secondary information associated with each entity in the population of entities. More specifically, the computer system can generate the prospect model characterizing attributes of a prospect for the organization, such as a prospect model characterizing attributes of a prospect most likely to complete a sale with the organization.

### Historical Data

Generally, the computer system can access historical data associated with an organization and a population of entities.

In one implementation, in block S112, the computer system can access a set of customer relationship management (or “CRM”) records associated with the organization, the set of CRM records representing a set of opportunities between the organization and a population of entities, such as existing customers and/or prospects of the organization. In particular, the computer system can access the set of CRM records, the set of CRM records specifying for each corresponding opportunity: an entity; a duration of time spent in a sales process; a result of an opportunity (e.g., closed-won, closed-lost); a sales amount; and/or other information associated with the opportunity.

In one example, the computer system can access the set of CRM records including a first subset of CRM records associated with a first subset of closed-won opportunities—in the set of opportunities—between the organization and a first subpopulation of entities in the population of entities. In another example, the computer system can access the set of CRM records including a second subset of CRM records associated with a second subset of closed-lost opportunities—in the set of opportunities—between the organization and a second subpopulation of entities in the population of entities.

In another implementation, the computer system can access a first set of CRM records from a first CRM platform in response to a login on the first CRM platform by a client. Additionally, the computer system can: access a second set of CRM records from a second CRM platform in response to a login on the second CRM platform by the client; access a third set of CRM records from a third CRM platform in response to a login on the third CRM platform by the client; and so on. Additionally or alternatively, the computer system can access any other historical and/or non-historical data associated with an organization.

Additionally or alternatively, the computer system can access any other historical (or non-historical data) associated with an organization and/or the population of entities. For example, the computer system can access server logs specifying traffic data for a website associated with the organization.

4.2 Company Information

Generally, the computer system can access company information associated with the population of entities.

In one implementation, in block S114, for each entity in the population of entities, the computer system can access company information associated with an entity. For example, for a first entity in the population of entities, the computer system can access company information including: industry classification identifier (e.g., North American Industry Classification System code number); technology category; company size (e.g., number of employees); amount of capital raised; estimated annual revenue; location; and/or other information associated with the first entity.

In one variation, the computer system can access the company information for each entity in the first subpopulation of entities (i.e., entities associated with a closed-won opportunity) and/or the second subpopulation of entities (i.e., entities associated with a closed-lost opportunity).

In another implementation, the computer system can access the company information from a data repository (or a set of data repositories) storing company information associated with a population of companies.

### Prospect Model Generation

Generally, the computer system can generate a prospect model for the organization based on the historical data and the company information. More specifically, the computer system can generate the prospect model based on the historical data (e.g., the set of CRM records, website traffic data) and the company information, the prospect model characterizing attributes of a prospect most likely to complete a sale with the organization.

### Feature Extraction

In one implementation, for a first opportunity in the set of opportunities, the computer system can extract a first set of primary features (e.g., company name, duration of time in sale process, result, sales amount)—in a population of sets of primary features—from a CRM record(s) corresponding to the first opportunity in block S114. Additionally or alternatively, the computer system can extract the first set of primary features (e.g., number of page views, duration of page views, URL path(s), page visit history) from website traffic data associated with a website page visit by the entity, as described below.

In another implementation, the computer system can: assign, as a first set of secondary features, company information corresponding to a first entity associated with the first opportunity in block S116; and generate a first data container (e.g., multi-dimensional vector), in a set of data containers, representing the first set of primary features and the first set of secondary features in a multi-dimensional feature space in block S118.

The computer system can repeat blocks S114, S116, and S118 for each opportunity in the set of opportunities. Alternatively, the computer system can repeat blocks S114, S116, and S118 for each opportunity in one or more subsets of opportunities (e.g., subset of closed-won opportunities, subset of closed-lost opportunities) in the set of opportunities.

### 4.3,2 Data Container Groups

In one implementation, in block S120, the computer system can group neighboring data containers (e.g., neighboring vectors), in the set of data containers, in the multi-dimensional feature space into a set of discrete clusters (or “data container groups”) exhibiting similar combinations of features and/or similar feature ranges in one or more dimensions in the multi-dimensional feature space.

In one example, the computer system can group a first subset of vectors in a set of vectors into a first vector group representing a first combination of features (or “attributes”) of a company most likely to yield a closed-won opportunity with the organization. In this example, the computer system can group the first subset of vectors into the first vector group representing the first combination of features, the first combination of features including: Internet software & services industry; $10-50 million estimated annual revenue; company size of 251-1,000 employees; and/or located in the United States; etc.

Accordingly, the computer system can fuse actual historical performance data (e.g., sales data) with company information related to a population of entities to identify a specific combination of attributes exhibited by a company most likely to yield a closed-won opportunity with the organization. Therefore, the computer system can leverage this specific combination of attributes to identify prospects for the organization to pursue, such as prospects that exhibit a high likelihood of making a purchase from the organization and/or a low level of difficulty in completing a sale.

In another example, the computer system can group a second subset of vectors in the set of vectors into a second vector group representing a second combination of features of a company least likely to yield a closed-won opportunity with the organization (and/or most likely to yield a closed-lost opportunity). In this example, the computer system can group the second subset of vectors into the second vector group representing the second combination of features, the second combination of features including: marketplace industry; $0-1 million estimated annual revenue; company size of 1-10 employees; and/or authentication services technology category; etc.

Accordingly, the computer system can fuse actual historical performance data (e.g., sales data) with company information related to a population of entities to identify a specific combination of attributes exhibited by a company least likely to yield a closed-won opportunity with the organization. Therefore, the computer system can leverage this specific combination of attributes to identify prospects for the organization to avoid, such as prospects that exhibit a low likelihood of making a purchase from the organization and/or a high level of difficulty in completing a sale.

Additionally or alternatively, the computer system can implement other structured data analysis techniques (e.g., linear regression analysis, cluster analysis, k-means clustering, and/or other statistical and machine learning techniques) to derive relationships and/or correlations between data containers (e.g., vectors, tensors) and partition these data containers into a set of data container groups.

### 5. PROSPECT PROFILE

Generally, the computer system can: generate a prospect profile for the organization based on the prospect model; and serve (or present) the prospect profile (e.g., an ideal prospect profile) at a client portal.

In one implementation, in block S130, the computer system can generate the prospect profile based on the first combination of features of a company most likely to yield a closed-won opportunity with the organization. In this implementation, the computer system can generate the prospect profile specifying a first set of attributes characteristic of entities that resulted in a closed-won opportunity with the organization.

For example, the computer system can generate the prospect profile specifying the first set of attributes including: a first set of tags (e.g., B2B, enterprise, technology); a first set of industries (e.g., Internet software & services, advertising, broadcasting, movies & entertainment, consulting, education); a first set of estimated annual revenues (e.g., $10-50 million); a first set of company sizes (e.g., 251-1,000 employees); a first set of locations (e.g., U.S.A.); and/or a first set of technology categories (e.g., payment, data processing, monitoring); etc.

In one implementation, the computer system can generate the prospect profile specifying, for each attribute in the first set of attributes, a numerical value representing a likelihood of a company exhibiting the attribute resulting in a closed-won opportunity. Additionally, in response to detecting the numerical value exceeding a threshold (e.g., 15%, 25%, 50%), the computer system can indicate the attribute as a strong indicator of good fit.

Furthermore, the computer system can generate the prospect profile further based on the second combination of features of a company least likely to yield a closed-won opportunity with the organization (or most likely to yield a closed-lost opportunity). In particular, the computer system can generate the prospect profile further specifying a second set of attributes characteristic of entities that resulted in a closed-lost opportunity with the organization.

For example, the computer system can generate the prospect profile specifying the second set of attributes including: a second set of tags (e.g., marketplace); a second set of industries (e.g., consumer discretionary); a second set of estimated annual revenues (e.g., $0-1 million); a second set of company sizes (e.g., 1-10 employees); and/or a second set of technology categories (e.g., geolocation, authentication services); etc.

In one implementation, the computer system can generate the prospect profile specifying, for each attribute in the second set of attributes, a numerical value representing a likelihood of a company exhibiting the attribute resulting in a closed-lost opportunity. Additionally, in response to detecting the numerical value exceeding a threshold (e.g., 15%, 25%, 50%), the computer system can indicate the attribute as a strong indicator of poor fit.

The computer system can serve (or present) the prospect profile at an operator portal in block S132.

Accordingly, the computer system can present, at an operator portal, a prospect profile specifying a first set of attributes characteristic of entities that resulted in a closed-won opportunity with the organization and a second set of attributes characteristic of entities that resulted in a closed-won opportunity with the organization. Therefore, the computer system enables a client to visualize combinations of attributes to pursue in a prospect to increase a likelihood of resulting in a closed-won opportunity and combinations of attributes to avoid in a prospect to decrease a likelihood of resulting in a closed-lost opportunity.

### 5.1 Fit Score

Generally, the computer system can calculate a fit score for a company based on the prospect model, the fit score representing a probability of the company completing a sale with the organization (and/or a level of difficulty for the organization to complete a sale with the company).

In one implementation, for each company in a population of companies, the computer system can: access company information corresponding to a company in block S112; assign, as a set of secondary features, company information corresponding to the company in block S116; generate a data container representing the set of secondary features in a multi-dimensional feature space in block S118; and calculate a fit score for the company based on a similarity between the data container and the first data container group representing the first combination of features of a customer most likely to yield a closed-won opportunity with the organization in block S150.

In one example, the computer system can calculate a relatively high fit score (e.g., 90%) for a first company based on a strong similarity between a first data container—corresponding to the first company—and the first data container group, the relatively high fit score representing a relatively high probability (e.g., 90%) of the first company completing a sale with the organization and/or a relatively low level of difficulty (e.g., 10% difficulty) for the organization to complete a sale with the first company.

In another example, the computer system can calculate a relatively low fit score (e.g., 5%) for a second company based on a strong dissimilarity between a second data container—corresponding to the second company—and the first data container group, the relatively low fit score representing a relatively low probability (e.g., 5%) of the second company completing a sale with the organization and/or a relatively high level of difficulty (e.g., 95% difficulty) for the organization to complete a sale with the second company.

### 5.2 Exemplary Companies

In one implementation, the computer system can generate the prospect profile further specifying a list of a first set of companies, each company in the first set of companies exhibiting a relatively high fit score, such as a fit score exceeding a first threshold (e.g. 80%), and representing an exemplary company most likely to complete a sale with the organization. Additionally, the computer system can generate the prospect profile further specifying a list of a second set of companies, each company in the second set of companies exhibiting a relatively low fit score, such as a fit score falling below a second threshold (e.g., 15%), and representing an exemplary company least likely to complete a sale with the organization.

In this implementation, for each company in the first set of companies and the second set of companies, the computer system can generate the prospect profile further specifying: a name; a logo; a website; an industry and/or category of service; a company size; an estimated annual revenue; and/or a label associated with the fit score (e.g., a “great” label for a fit score between 90-100%, a “good” label for a fit score between 80-89%, a “bad” label for a fit score between 0-15%); etc.

Accordingly, the computer system can proactively identify and recommend, at an operator portal, an exemplary set of companies exhibiting high fit scores representing high likelihood of completing a sale with the organization—even absent prior knowledge or engagement between these companies and the organization.

### 6. HISTORICAL PROSPECTS

Generally, the computer system can: identify a set of prospects (e.g., new prospects unknown to the organization) based on traffic data corresponding to a website associated with the organization; generate a report specifying a list of the set of prospects and information (e.g., company information, contact information) associated with the set of prospects; and serve (or present) the report at an operator portal.

In one implementation, the computer system can: access a set of traffic data corresponding to a set of page views on a website associated with the organization in block S140; and identify a set of prospects based on the set of traffic data in block S142. More specifically, the computer system can: identify a set of IP addresses associated with the set of page views based on the set of traffic data; and correlate the set of IP addresses with the set of prospects, each IP address in the set of IP addresses associated with a prospect in the set of prospects. For example, the computer system can access a database (or a set of databases) mapping IP addresses (or ranges of IP addresses) to a population of companies.

In another implementation, the computer system can generate a fit score for each prospect in the set of prospects, as described above. More specifically, for each prospect in the set of prospects, the computer system can: extract a first set of primary features (e.g., number of page views, duration of page views, URL path(s), page visit history) from the set of traffic data associated with a website page visit by a prospect in block S114; access company information corresponding to the prospect in block S112; assign, as a set of secondary features, company information corresponding to the prospect in block S116; generate a data container representing the set of secondary features in a multi-dimensional feature space in block S118; and calculate a fit score for the prospect based on a similarity between the data container and the first data container group representing the first combination of features of a prospect most likely to yield a closed-won opportunity with the organization in block S150.

In one implementation, in block S170, the computer system can generate a report specifying a list of the set of prospects and, for each prospect in the set of prospects: a name; a logo; a website; an industry and/or category of service; a company size; an estimated annual revenue; fit score; a label associated with the fit score; and/or website activity (e.g., number of page views, duration of page views, URL path(s), page visit history); etc. Additionally, the computer system can generate the report further specifying, for each prospect in the set of prospects, contact formation (e.g., email address, phone number) for a specified role and/or key buyer (e.g., CEO, CTO, executive, head of product, program manager). For example, the computer system can populate the report based on company information stored in a data repository (or a set of data repositories).

In this implementation, the computer system can order (or sort) the set of prospects, such as based on a fit score (e.g., highest fit score first) of a prospect in the set of prospects and/or based on latest page visit (e.g., latest visit first). Additionally or alternatively, the computer system can generate the report for a subset of prospects in the set of prospects, each prospect in the subset of prospects exhibiting a fit score exceeding a threshold (e.g., 40%, 60%).

The computer system can serve (or present) the report at an operator portal in block S172.

Additionally, the computer system can repeat this process to periodically generate and present reports, at the operator portal, specifying a list of an updated set of prospects based on website traffic data during various time periods.

Accordingly, the computer system can: identify new prospects exhibiting an interest in the organization (e.g., by visiting a website of the organization); and present, at an operator portal, a list of these prospects and corresponding contact information for key personnel, thereby driving prospects even in an absence of website forms completed by these prospects.

### 7. REAL-TIME PROSPECTS

Generally, the computer system can: identify a prospect based on real-time traffic data corresponding to a website associated with the organization; calculate a fit score associated with the prospect; and autonomously execute a task (or a set of tasks) based on the fit score and/or attributes associated with the prospect.

In one implementation, the computer system can: access (or monitor) a set of traffic data (e.g., real-time traffic data) corresponding to a set of page views on a website associated with the organization in block S140; and identify a prospect based on the set of traffic data in block S142 in an analogous (e.g., similar, identical) manner as described above. The computer system can then generate a fit score for the prospect in blocks S150, as described above.

### 7.1 Automated Tasks

Generally, the computer system can autonomously execute a task (or a set of tasks) based on a fit score and/or a set (or subset) of attributes associated with a detected prospect.

### 7.1.1 Automated Notification

In implementation, in block S150, the computer system can generate a notification at an operator device based on a fit score associated with a detected prospect.

In one example, in response to detecting a first fit score associated with a first prospect falling within a first range of fit score (e.g., 50-74%), the computer system can: specify the first prospect in a digest (e.g., email digest) indicating a list of prospects within a predefined time period (e.g., week); and serve the digest to a client (or a set of clients) according to the predefined time period (e.g., weekly every Monday).

In another example, in response to detecting a second fit associated with a second prospect falling within a second range of a fit score (e.g., 75-100%), the computer system can: generate and serve a real-time notification (e.g., an alert) to an client (or a set of clients), at an operator device (or a set of operator devices), indicating the second prospect exhibiting a high fit score. In this example, the computer system can generate the real-time notification specifying the second prospect and company information (e.g., company name, contact information for key personnel) associated with the second prospect.

Accordingly, the computer system can: identify prospects exhibiting an interest in the organization (e.g., by visiting a website of the organization); and specify these prospects in different types of notifications (e.g., real-time notification, weekly digest) to a client, at an operator portal (or an operator device), based on fit scores of these prospects, thereby enabling a client to leverage a prospect's active interest in the organization while prioritizing prospects exhibiting highest likelihood of completing a sale with the organization.

### 7.1.2 Automated CRM Accounts

In another implementation, in block S180, in response to detecting the fit score exceeding a threshold (e.g., 60%), the computer system can generate an account, in a CRM platform, associated with the prospect. In this example, the computer system can populate the account based on attributes (and/or company information) associated with the prospect (e.g., company name, contact information for key personnel, location).

Additionally, the computer system can assign the account to an account owner based on the fit score and/or the set of attributes. In one example, in response to detecting a first fit score, associated with a first prospect, exceeding a first threshold (e.g., 50%) and, in response to detecting the first prospect exhibiting a location attribute of “San Francisco, CA,” the computer system can assign a first account, associated with the first prospect, to Salesperson A in a San Francisco office of the organization. In another example, in response to detecting a second fit score, associated with a second prospect, exceeding a second threshold (e.g., 90%) and in response to detecting the second prospect exhibiting a location attribute of “Austin, TX,” the computer system can assign a second account, associated with the second prospect, to Sales Manager B in an Austin office of the organization. In these examples, the computer system can notify an account owner, at an operator portal (or operator device) associated with the account owner, of the detected prospect. More specifically, the computer system can generate a notification specifying the detected prospect and company information associated with the detected prospect.

Accordingly, the computer system can autonomously: generate CRM platform accounts for qualified prospects (e.g., prospects exhibiting a fit score exceeding a threshold); and assign these accounts to various account owners associated with the organization based on fit scores and/or attributes of these prospects, thereby enabling the organization to pair prospects with personnel (e.g., account owners) that best match needs of these prospects.

### 8. PROSPECT MODEL UPDATE

Generally, the computer system can update a prospect model for an organization based on an updated set of CRM records and/or an updated set of traffic data for a website associated with the organization.

In one implementation, the computer system can periodically (e.g., weekly, monthly, quarterly) update a prospect model based on an updated set of CRM records, updated company information, and/or an updated set of traffic data for a website associated with the organization. In this implementation, the computer system can weight the updated CRM records, updated company information, and/or the updated set of traffic data more heavily than prior data (e.g., prior CRM records, prior company information, and/or prior website traffic data) when updating the prospect model.

### 9. CONCLUSION

In some embodiments, a method is provided. The method includes extracting a set of primary features from historical data for an opportunity between an organization and an entity; generating a data container to represent the set of primary features and a set of secondary features associated with the entity; grouping neighboring data containers, within a set of data containers that includes the data container, into data container groups; selecting a data container group representing a combination of features of the entity predicted to yield with opportunity for the organization; and utilizing the combination of features to generate and transmit content to the entity.

In some embodiments, the method includes generating the data container as a vector that represents the set of primary features and the second of secondary features in a multi-dimensional feature space.

In some embodiments, the method includes grouping the neighboring data containers in a multi-dimensional feature space into the set of data container groups.

In some embodiments, the method includes generating a notification for a prospect identified from traffic data associated with a set of page views of a website, wherein the prospect is selected based upon a fit score corresponding to a similarity between the data container group and the data container associated with the prospect.

In some embodiments, the method includes generating a model characterizing attributes of a target prospect for the organization, wherein a fit score is used to select the entity as corresponding to the target prospect.

In some embodiments, the method includes generating, utilizing a prospect model, a target prospect profile specifying a list of attributes and entities that exhibit attributes associated with the opportunity to occur, wherein the target prospect profile is utilized to create the content.

In some embodiments, the method includes characterizing and recommending, utilizing a prospect model, attributes and entities that exhibit the attributes.

In some embodiments, the method includes utilizing fit scores assigned to entities to generate and provide notifications identifying prospects that exhibit an interest in the organization.

In some embodiments, the method includes utilizing fit scores assigned to entities to generate a first type of notification for a first subset of prospect and a second type of notification for a second subset of prospect.

In some embodiments, a computing device is provided. The computing device comprises a memory comprising machine executable code; and a processor coupled to the memory, the processor configured to execute the machine executable code to cause the processor to: extract a set of primary features from historical data for an opportunity between an organization and an entity; generate a data container to represent the set of primary features and a set of secondary features associated with the entity; group neighboring data containers, within a set of data containers that includes the data container, into data container groups; select a data container group representing a combination of features of the entity predicted to yield with opportunity for the organization; and utilize the combination of features to generate and transmit content to the entity.

In some embodiments, the machine executable code causes the processor to: utilize fit scores assigned to entities to generate a first type of notification for a first subset of prospect and a second type of notification for a second subset of prospect.

In some embodiments, the machine executable code causes the processor to: generate the data container as a vector that represents the set of primary features and the second of secondary features in a multi-dimensional feature space.

In some embodiments, the machine executable code causes the processor to: group the neighboring data containers in a multi-dimensional feature space into the set of data container groups.

In some embodiments, the machine executable code to causes the processor to: generate a notification for a prospect identified from traffic data associated with a set of page views of a website, wherein the prospect is selected based upon a fit score corresponding to a similarity between the data container group and the data container associated with the prospect.

In some embodiments, the machine executable code causes the processor to: generate a model characterizing attributes of a target prospect for the organization, wherein a fit score is used to select the entity as corresponding to the target prospect.

In some embodiments, the machine executable code causes the processor to: generate, utilizing a prospect model, a target prospect profile specifying a list of attributes and entities that exhibit attributes associated with the opportunity to occur, wherein the target prospect profile is utilized to create the content.

In some embodiments, a non-transitory machine readable medium is provided. The non-transitory machine readable medium comprises instructions for performing a method, which when executed by a machine, causes the machine to: extract a set of primary features from historical data for an opportunity between an organization and an entity; generate a data container to represent the set of primary features and a set of secondary features associated with the entity; group neighboring data containers, within a set of data containers that includes the data container, into data container groups; select a data container group representing a combination of features of the entity predicted to yield with opportunity for the organization; and utilize the combination of features to generate and transmit content to the entity.

In some embodiments, the instructions cause the machine to: generate, utilizing a prospect model, a target prospect profile specifying a list of attributes and entities that exhibit attributes associated with the opportunity to occur, wherein the target prospect profile is utilized to create the content.

In some embodiments, the instructions cause the machine to: characterize and recommend, utilizing a prospect model, attributes and entities that exhibit the attributes.

In some embodiments, the instructions cause the machine to: utilize fit scores assigned to entities to generate and provide notifications identifying prospects that exhibit an interest in the organization.

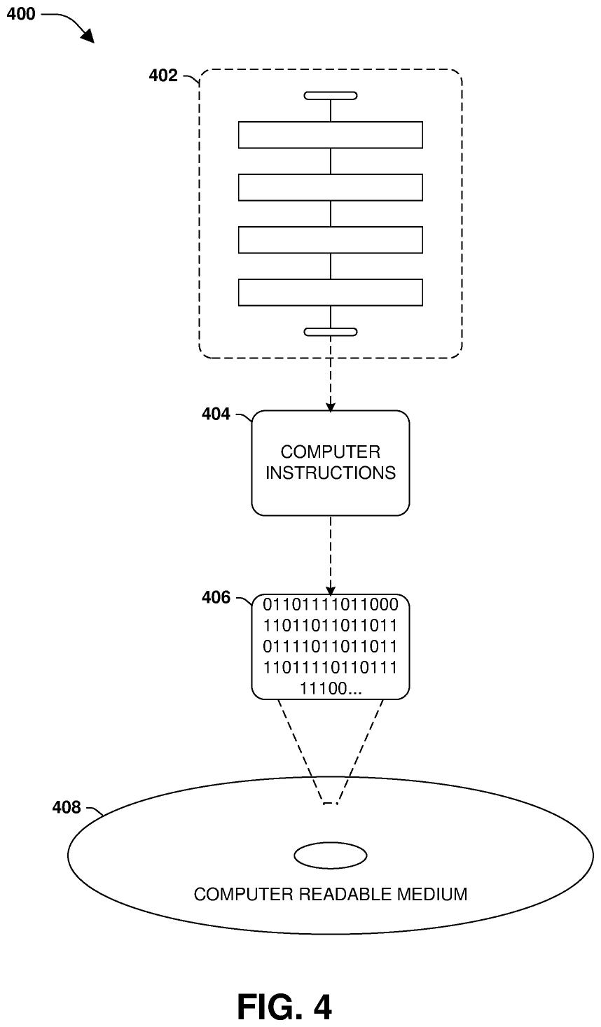

A computer-readable medium comprises processor-executable instructions configured to implement one or more of the techniques presented herein. An example embodiment of a computer-readable medium or a computer-readable device is illustrated in FIG. 4, wherein the implementation 400 comprises a computer-readable medium 408, such as a CD-R, DVD-R, flash drive, a platter of a hard disk drive, etc., on which is encoded computer-readable data 406. This computer-readable data 406, such as binary data comprising at least one of a zero or a one, in turn comprises a set of computer instructions 404 configured to operate according to one or more of the principles set forth herein. In some embodiments, the processor-executable computer instructions 404 are configured to perform a method 402, for example. In some embodiments, the processor-executable instructions 404 are configured to implement a system, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Many modifications may be made to this configuration without departing from the scope or spirit of the claimed subject matter.

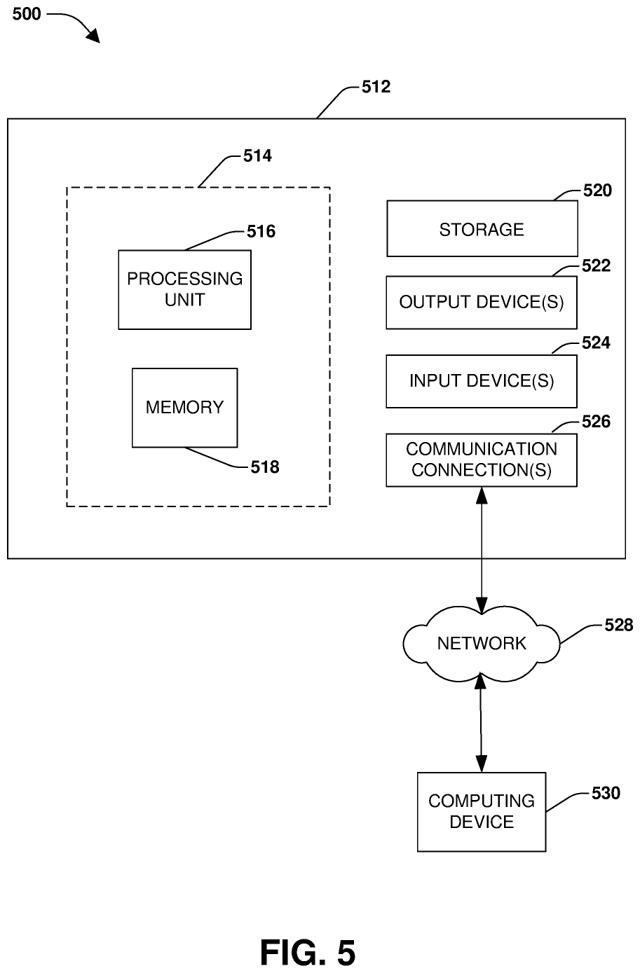

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 500 comprising a computing device 512 configured to implement one or more embodiments provided herein. In one configuration, computing device 512 includes at least one processing unit 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514. In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processing unit 516, for example. The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Computer storage media does not, however, include propagated signals. Rather, computer storage media excludes propagated signals. Any such computer storage media may be part of device 512.

Device 512 may also include communication connection(s) 526 that allows device 512 to communicate with other devices. Communication connection(s) 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection(s) 526 may include a wired connection or a wireless connection. Communication connection(s) 526 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 512 may include input device(s) 524 such as keyboard, mouse, pen, voice input device, touch input device, infrared cameras, video input devices, and/or any other input device. Output device(s) 522 such as one or more displays, speakers, printers, and/or any other output device may also be included in device 512. Input device(s) 524 and output device(s) 522 may be connected to device 512 via a wired connection, wireless connection, etc. In one embodiment, an input device or an output device from another computing device may be used as input device(s) 524 or output device(s) 522 for computing device 512. Components of computing device 512 may be connected by various interconnects, such as a bus. Components of computing device 512 may be interconnected by a network. For example, memory 518 may be comprised of multiple physical memory units located in different physical locations interconnected by a network. For example, a computing device 530 accessible via a network 528 may store computer readable instructions to implement one or more embodiments provided herein.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
extracting a set of primary features from historical data for an opportunity between an organization and an entity;
generating a data container to represent the set of primary features and a set of secondary features associated with the entity;
grouping neighboring data containers, within a set of data containers that includes the data container, into data container groups;
selecting a data container group representing a combination of features of the entity predicted to yield with opportunity for the organization; and
utilizing the combination of features to generate and transmit content to the entity.

2. The method of claim 1, comprising:
generating the data container as a vector that represents the set of primary features and the second of secondary features in a multi-dimensional feature space.

3. The method of claim 1, comprising:
grouping the neighboring data containers in a multi-dimensional feature space into the set of data container groups.

4. The method of claim 1, comprising:
generating a notification for a prospect identified from traffic data associated with a set of page views of a website, wherein the prospect is selected based upon a fit score corresponding to a similarity between the data container group and the data container associated with the prospect.

5. The method of claim 1, comprising:
generating a model characterizing attributes of a target prospect for the organization, wherein a fit score is used to select the entity as corresponding to the target prospect.

6. The method of claim 1, comprising:
generating, utilizing a prospect model, a target prospect profile specifying a list of attributes and entities that exhibit attributes associated with the opportunity to occur, wherein the target prospect profile is utilized to create the content.

7. The method of claim 1, comprising:
characterizing and recommending, utilizing a prospect model, attributes and entities that exhibit the attributes.

8. The method of claim 1, comprising:
utilizing fit scores assigned to entities to generate and provide notifications identifying prospects that exhibit an interest in the organization.

9. The method of claim 1, comprising:
utilizing fit scores assigned to entities to generate a first type of notification for a first subset of prospect and a second type of notification for a second subset of prospect.

10. A computing device comprising:
a memory comprising machine executable code; and
a processor coupled to the memory, the processor configured to execute the machine executable code to cause the processor to:
extract a set of primary features from historical data for an opportunity between an organization and an entity;
generate a data container to represent the set of primary features and a set of secondary features associated with the entity;
group neighboring data containers, within a set of data containers that includes the data container, into data container groups;
select a data container group representing a combination of features of the entity predicted to yield with opportunity for the organization; and
utilize the combination of features to generate and transmit content to the entity.

11. The computing device of claim 10, wherein the machine executable code causes the processor to:
utilize fit scores assigned to entities to generate a first type of notification for a first subset of prospect and a second type of notification for a second subset of prospect.

12. The computing device of claim 10, wherein the machine executable code causes the processor to:
generate the data container as a vector that represents the set of primary features and the second of secondary features in a multi-dimensional feature space.

13. The computing device of claim 10, wherein the machine executable code causes the processor to:
group the neighboring data containers in a multi-dimensional feature space into the set of data container groups.

14. The computing device of claim 10, wherein the machine executable code causes the processor to:
generate a notification for a prospect identified from traffic data associated with a set of page views of a website, wherein the prospect is selected based upon a fit score corresponding to a similarity between the data container group and the data container associated with the prospect.

15. The computing device of claim 10, wherein the machine executable code causes the processor to:
generate a model characterizing attributes of a target prospect for the organization, wherein a fit score is used to select the entity as corresponding to the target prospect.

16. The computing device of claim 10, wherein the machine executable code causes the processor to:
generate, utilizing a prospect model, a target prospect profile specifying a list of attributes and entities that exhibit attributes associated with the opportunity to occur, wherein the target prospect profile is utilized to create the content.

17. A non-transitory machine readable medium comprising instructions for performing a method, which when executed by a machine, causes the machine to:
extract a set of primary features from historical data for an opportunity between an organization and an entity;
generate a data container to represent the set of primary features and a set of secondary features associated with the entity;
group neighboring data containers, within a set of data containers that includes the data container, into data container groups;
select a data container group representing a combination of features of the entity predicted to yield with opportunity for the organization; and
utilize the combination of features to generate and transmit content to the entity.

18. The non-transitory machine readable medium of claim 17, wherein the instructions cause the machine to:
generate, utilizing a prospect model, a target prospect profile specifying a list of attributes and entities that exhibit attributes associated with the opportunity to occur, wherein the target prospect profile is utilized to create the content.

19. The non-transitory machine readable medium of claim 17, wherein the instructions cause the machine to:
characterize and recommend, utilizing a prospect model, attributes and entities that exhibit the attributes.

20. The non-transitory machine readable medium of claim 17, wherein the instructions cause the machine to:
utilize fit scores assigned to entities to generate and provide notifications identifying prospects that exhibit an interest in the organization.
